(19) United States
(12) Patent Application Publication
(10) Pub. No.: US 2009/0107002 A1
(43) Pub. Date: Apr. 30, 2009

(54) Method And System For Forcing Evaporation Of A Solvent From A Coating

(76) Inventor: Andras Uhlyarik, Apple Valley, CA (US)

Correspondence Address: Law Office of MICHAEL D. EISENBERG;Intellectual Property Law, 6023 Vista De La Mesa, LA JOLLA, CA, 92037, US

(21) Appl. No.: 12/258,369

(22) Filed: Oct. 24, 2008

Related U.S. Application Data
(60) Provisional application No. 61/000,379, filed on Oct. 25, 2007.

(51) Int. Cl. F26B 9/06; F26B 21/00

(52) U.S. Cl. 34/487; 34/443; 34/666; 34/210; 34/229

(57) ABSTRACT

A system and method is provided for forcing evaporation of a solvent from a coating on a surface of a panel. The method includes directing air to flow along the surface of the panel, and generating turbulence in the air within the column, by creating one or more high pressure pulses of air within the airflow, at a chosen frequency. The turbulence travels in the direction of the airflow, replacing air laden with vapor adjacent to the surface of the panel with dry air, thereby accelerating drying.

### CROSS-REFERENCE TO RELATED APPLICATIONS

This application claims priority from U.S. provisional application Ser. No. 61/000,379 filed on Oct. 25, 2007, which is hereby incorporated herein by reference in its entirety.

### TECHNICAL FIELD

The present invention relates to a method and a system for forcing evaporation of a solvent from a coating, and more particularly, to a method and a system for drying water based a coating on a surface of a motor vehicle.

### BACKGROUND OF THE INVENTION

Because of recent environmental regulations, paint companies are developing coatings characterized by low Volatile Organic Compound (VOC) content. Most of these coatings are waterborne coatings, in which water replaces VOC pigment carriers to reduce pollution. In many industries, the use of waterborne coatings is growing at a high rate.

In order to dry a waterborne coating, water is drawn out of the coating by creating the right environment on the surface of the coating. The rate of water evaporation from the coating to the outlying environment depends on the vapor pressure difference between the coating and the surrounding air.

In the automotive industry, traditional spray enclosures are built to create smooth or laminar flow of air along surfaces covered by coatings. When an object with a painted surface is placed into a laminar airflow, a slow moving layer of air develops on the painted surface of the object. This layer is called the “boundary layer”, and is found in region in the vicinity of the coating, usually within 0.25-0.50 inches of the coating. Because airflow is very slow in the boundary layer, the boundary layer eventually saturates with water vapor. When saturated with water vapor, this layer insulates the coating from the rest of the air inside the spray enclosure effectively stopping the drying process.

A solution to this problem is the introduction of lower relative humidity air onto the surface of the coating. In the art, this is generally achieved by the creation of turbulence. Turbulence breaks up the smooth airflow and eliminates the boundary layer. This increases the vapor pressure difference between the coating and the surrounding air, and facilitates proper dehydration of the coating.

In the art, many methods have been designed to create a turbulent airflow, for drying a waterborne coating. U.S. Pat. No. 6,192,604 by Morrison discloses a system in which a first air flow is directed toward a surface of a painted body, and a second air flow is directed transversely to the first air flow, to create turbulence within the first air flow. In such a system, however, both the first and second airflows slow each other down, and the speed of the flow along the painted surface of the vehicle is reduced. A lower speed of the air flowing along the painted surface generally means a higher flash-off time. Furthermore, the second airflow needs be transverse to the first airflow.

U.S. Pat. No. 7,045,013 by DeRegge discloses a system in which a fan increases airflows within the interior of a booth, in order to dry a coating applied to a surface of an object. However, as the airflow reaches a critical speed, for example 350 feet per minute, such a system may stir up dry overspray particles located on the floor of the booth, even with the exhaust fans running. Overspray particles are particles of dry coating and are generally larger than 10 microns. Once stirred up, overspray particles may land on the wet coating covering the object's surface and thereby cause defects on the coating's surface.

### BRIEF SUMMARY OF EMBODIMENTS OF THE INVENTION

According to one embodiment of the invention, a method and system are provided, for forcing evaporation of a solvent from a coating on a surface of a panel, through an airflow characterized by turbulence moving in the same direction of the airflow.

A method is provided for forcing evaporation of a solvent from a coating on a surface of a panel. The method includes directing air to flow along the surface of the panel, and generating turbulence in the air within the column, by creating one or more high pressure pulses of air within the airflow, at a chosen frequency. The turbulence travels in the direction of the airflow, replacing air laden with vapor adjacent to the surface of the panel with dry air, thereby accelerating drying.

In a variant, the air is directed toward the surface of the panel through a nozzle in the form of an air column, the column being inclined to the plane of the panel, such that the airflow travels along the surface of the panel.

In another variant, a plurality of columns of air is directed toward the panel, each column through a different nozzle, so that air from the columns flows over substantially the whole surface of the panel.

In a further variant, a low pressure pulse follows each high pressure pulse.

In yet another variant, the frequency is chosen, such that the air flows along the surface of the panel at a desired speed between pulses.

Optionally, creating high pressure and low pressure pulses is achieved by turning the air supply on and off at the chosen frequency.

Optionally, creating high pressure and low pressure pulses is achieved by opening and closing ducting leading air from the air supply to the nozzle, at the chosen frequency.

Optionally, creating high pressure and low pressure pulses is achieved by introducing a sound wave, for disturbing the air flowing along the surface of the panel, thereby creating turbulence in the airflow.

In a variant, the solvent is water and the coating is waterborne coating.

In another variant, the method includes generating further turbulence within the air column, by forcing air within the column to rotate.

Optionally, forcing air to rotate is achieved by flowing air within the nozzle over a twisted surface inside the nozzle.

Another aspect of the present invention relates to a system for forcing evaporation of a solvent from a coating on a surface of a panel. The system includes: an air blower, for creating a flow of pressurized air; a nozzle plenum, for receiving the pressurized air from the air blower; a nozzle, for directing a column of air from the nozzle plenum toward the surface of the panel; a pulse generation unit, for generating a pressure pulse in the air column, thereby creating turbulence in air within the column, the pulse being characterized by a chosen frequency; and a control unit, for controlling an operation of the system. The column of air is inclined to the plane of the panel, such that the air within the column flows along the surface of the panel, and the turbulence travels in the direction of the flow, replacing air laden with solvent vapor adjacent to the surface with dry air, thereby accelerating drying.

Optionally, the system includes a plurality of nozzles, each nozzle configured for directing a column of air toward the panel, so that air from the columns flows over substantially the whole surface of the panel.

In a variant, the frequency is chosen, such that the air in the column reaches a desired speed between pulses.

In another variant, the pulse generation unit includes a timer connected to the control unit, and configured for turning the blower on and off at the chosen frequency.

In a further variant, the pulse generation unit includes a damper configured for opening and closing tubing leading air from the air blower to the nozzle plenum at the chosen frequency.

In yet another variant, the pulse generation unit includes a speaker for generating a sound wave configured for disturbing the air in the column, thereby creating turbulence in the column.

Optionally, the system further includes a twisted surface located within the nozzle, for generating a twisting airflow within the column, thereby creating further turbulence within the column.

Optionally, the solvent is water, and the coating is waterborne coating.

Optionally, the above system is included within a spray enclosure for drying a coating on a surface of a vehicle.

A further aspect of the present invention relates to a system for forcing evaporation of a solvent from a coating on a surface of a panel. The comprising: an air blower, for creating a flow of pressurized air; a nozzle plenum, for receiving the pressurized air from the air blower; a nozzle sheet, for supporting one or more nozzles, each nozzle directing a jet of air from the nozzle plenum toward the surface of the panel; and a control unit, for controlling an operation of the blower. The nozzle is held in place by the nozzle sheet, and is not movable. The nozzle sheet and the spray booth corner walls, or the nozzle panel, one spray booth wall and a metal panel to cover the third side, define the plenum that is pressurized by the blower. The nozzle sheet may have the nozzles welded into it. On top there may be a transition that allows a 6″ duct to be connected. Optionally, there can be 2 nozzle plenums or 4 nozzle plenums in an installation.

In a variant, the above system is configured for being placed in a spray enclosure for painting and drying a vehicle. The nozzle sheet has an orientation of 45 degrees with respect to a wall in a spray enclosure. The nozzle sheet supports two columns of nozzles. Each column of nozzles is characterized by a specific angle, chosen so that the air jets are inclined to the plane of the panel, such that the air from the air jets flows along a surface of the vehicle.

In another variant, the nozzle is grounded and made out of an electrically conductive material, to reduce a generation of static charge by the air rubbing rubs against the inside of the nozzle.

In a further variant, the spray enclosure is rectangular, and includes four nozzle plenums. On the first sheet, located on the first wall, one column of nozzles generates air jets flowing in a laminar manner along a back surface of the vehicle, and the other column of nozzles generates jets flowing in a laminar manner along a surface of a first side of the vehicle. On the second sheet, located on the first wall, one column of nozzles generates jets flowing in a laminar manner along the surface of the first side of the vehicle, and the other column of nozzles generates jets flowing in a laminar manner along a front surface of the vehicle. On the third sheet, located on the second wall and opposite the second sheet, one column of nozzles generates jets flowing in a laminar manner along the front surface of the vehicle, and the other column of nozzles generates jets flowing in a laminar manner along a surface of a second side of the vehicle. On the fourth sheet, located on the second wall and opposite the first sheet, one column of nozzles generates jets flowing in a laminar manner along the surface of the second side of the vehicle, and the other column of nozzles generates jets flowing in a laminar manner along the back surface of the vehicle.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIGS. 1a-1f are schematic drawings illustrating a painted surface of a panel dried by a pulsating airflow, according to some embodiments of the present invention;

FIG. 2a-2d are schematic drawings illustrating a painted surface dried by a rotating airflow, according to some embodiments of the present invention;

FIG. 3 is a photograph of a nozzle characterized by a twisted surface for twisting the airflow within the column exiting the nozzle, according to some embodiments of the present invention;

FIGS. 4a and 4b are schematic drawings illustrating a nozzle tower designed to be used in a spray enclosure, according to some embodiments of the present invention; and

FIGS. 5a and 5b are drawings illustrating a system for drying coating on a panel, according to some embodiments of the present invention.

The figures are not intended to be exhaustive or to limit the invention to the precise form disclosed. It should be understood that the invention can be practiced with modification and alteration, and that the invention be limited only by the claims and the equivalents thereof.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

Before describing aspects and embodiments of the present invention, some terms are to be defined. In this document, the term “panel” refers to any objects having a surface that may be covered by a coating. A panel may be, for example, a metallic sheet, a wooden board, or a glass window.

The term “coating” herein refers to a material used for covering a surface. A coating may be, for example, paint, varnish, or dye. A “painted surface” is a surface partially or fully covered by a coating.

The term “solvent” herein refers to a material present in the coating, and used for adjusting a viscosity of the coating. The solvent may also affect the stability of the coating while in liquid state. The solvent may be, for example, water, oil, alcohol, and methyl ethyl ketone (MEK). If the solvent is water, the coating is called “waterborne coating”.

The term “spray enclosure” refers to an enclosure in which painting and finishing operations performed. The spray enclosure may be a spray booth, which is a hard sided enclosure, used in the automotive industry for spraying a vehicle with a coating and drying the coating. The spray enclosure may also be a preparation station (also known in the automotive industry as “prep station”), which is enclosed by curtains and is used for preparing the vehicle for paint in the spray booth. Limited finishing operations are also performed in prep stations.

The present invention relates to a method and a system for forcing evaporation of a solvent from a coating, and more particularly, to a method and a system for drying waterborne coating on a surface of a motor vehicle.

An aspect of the present invention relates to a method for forcing evaporation of a solvent from a coating on a surface of a panel, including directing air to flow along the painted surface of the panel, and generating a turbulence traveling with the airflow. The turbulence replaces the air laden with solvent vapor with dry air. The above method is particularly useful, but not limited to drying a waterborne or an oil-based coating on a panel of a motor vehicle in a spray enclosure. Optionally, the air is directed towards the panel through a nozzle, in the form of an air column. The column is inclined to the plane of the panel, such that airflow is created along the surface of the panel.

In a variant, a plurality of air columns is directed through a plurality of nozzles toward the panel. Optionally, the air columns are horizontal in relation of the ground. Optionally, the airflow from the nozzles is the only airflow used for forcing the evaporation of the coating. Optionally, the horizontal airflow from the nozzles is a secondary airflow designed to produce turbulence within a primary airflow. The primary airflow may be one or more of a primary vertical airflow or a primary horizontal airflow. Thus, the above method may be applied to drying a coating in both a spray enclosure characterized by a primary vertical airflow and a spray enclosure characterized by a primary horizontal airflow.

In another variant, turbulence is generated within the air flowing along the surface of the panel by creating one or more high pressure pulses at a chosen frequency. Initially, a laminar airflow traveling along the panel is generated, and a boundary layer as described above is created. A high pressure pulse is then generated within the airflow. As the front of the high pressure pulse contacts the panel, the air traveling along the panel tumbles toward the boundary layer, removes the boundary layer, and brings air with lower level of relative humidity in contact with the panel.

In a further variant, turbulence is generated by causing the air within the column to move in a twisting fashion. In this manner, dry air is constantly brought into contact with the surface of the panel, and the boundary layer is not formed.

Another aspect of the present invention relates to a system for forcing evaporation of a solvent from a coating on a surface of a panel. The system is characterized by a nozzle, for directing a column of air toward the surface of the panel, and a pulse generation unit, for generating a pulse in the air column. The pulse within the air column creates turbulence within the air column, the turbulence traveling with the air in the column. Optionally, the nozzle includes a twisted surface for generating a twisting airflow within the column, thereby creating further turbulence within the column.

A further aspect of the present invention relates to a system for forcing evaporation of a solvent from a coating. The system is characterized by a nozzle sheet in which the nozzle is not movable, and therefore can't be moved out of alignment.

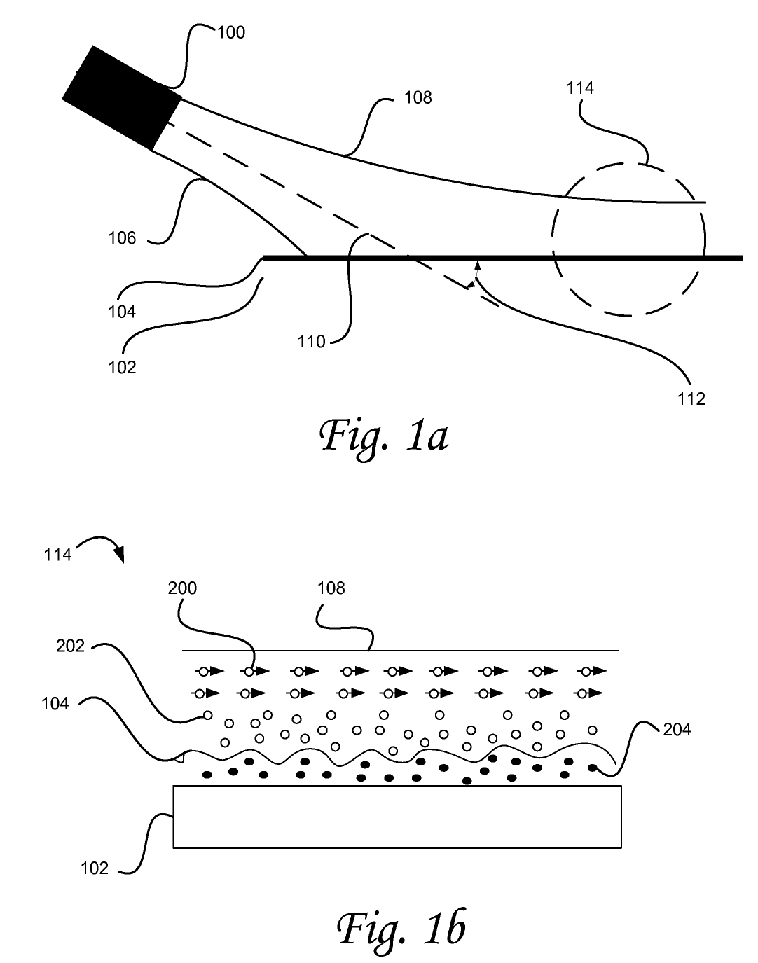

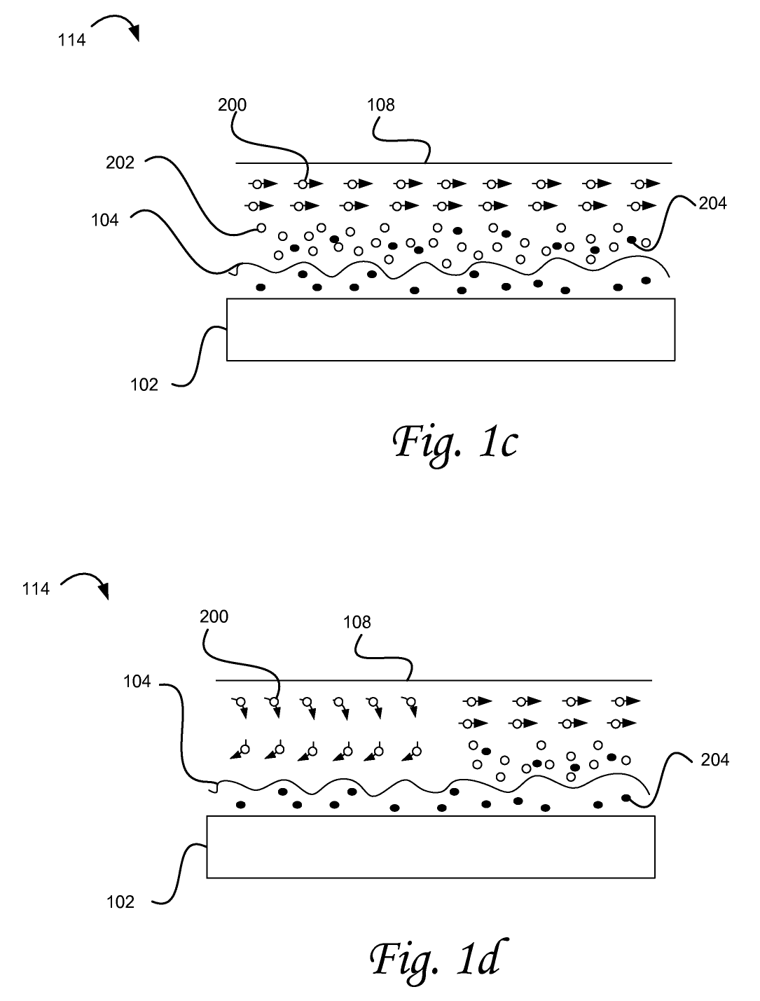

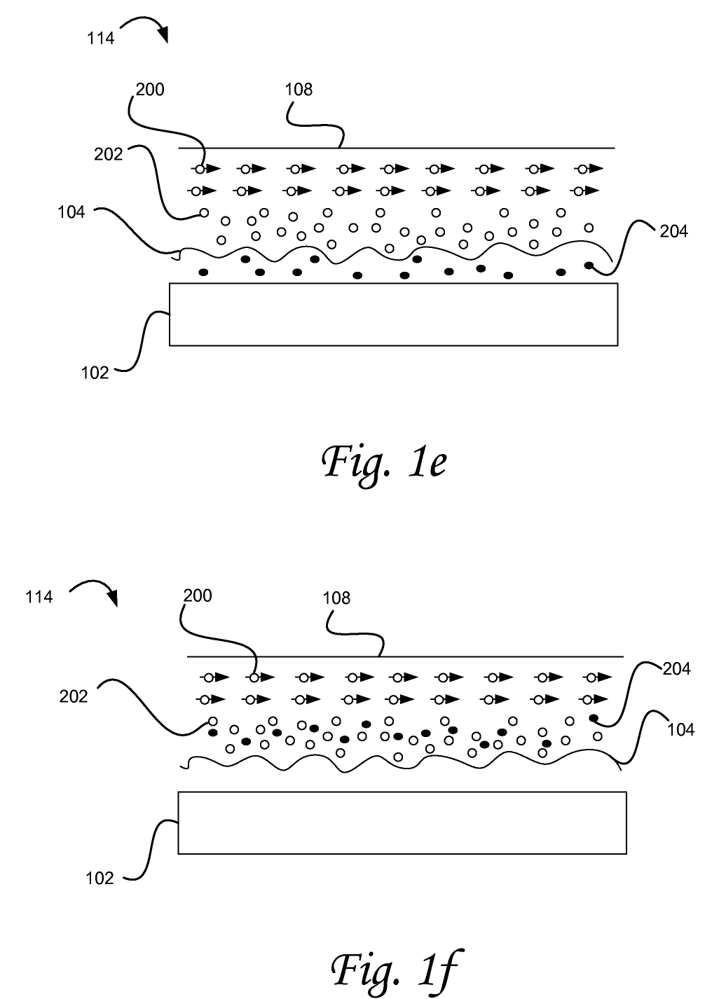

Referring now to the figures, FIGS. 1a-1f are schematic drawings illustrating a painted surface of a panel dried by a pulsating airflow, according to some embodiments of the present invention.

In FIG. 1a, a coating 104 on a surface of panel 102 is dried through a method, which includes: directing an air column through a nozzle 100 toward the surface of the panel 102, covered with the coating 104, in order to force evaporation of solvent molecules from the coating 104; and creating a directional turbulence within the air column. Generally, turbulence may be disruptive, as turbulence may slow down the flow of air within the column, reducing the speed of the airflow below a desired level, and therefore increasing the time in which the solvent evaporates. In contrast, directional turbulence travels with the air column, and therefore does not slow down the flow of air along the painted surface.

The air column is characterized by boundaries 106 and 108, and a center line 110, around which the column is centered. The angle 112 between the center line 110 and the painted surface of the panel 102 is chosen so that the air inside the column flows along the painted surface of the panel 102, while losing a reduced amount of speed from the impact with the surface of the panel 102. The choice of the angle 112 also depends on the velocity of the air in the column. In general, the closer the angle 112 is to zero, the more effective the drying process, since less speed is lost in the impact between the air column and the surface of the panel 102. In an exemplary embodiment of the present invention, the speed of the airflow at the tip of the nozzle is between about 6,000 ft/min and about 8,000 ft/min, the angle 112 is between 65 and 75 degrees, so that the speed of the airflow along the panel varies between 200 ft/min and 600 ft/min, depending on the distance the air in the column has traveled along the panel. Optionally, the air column is warmed to a specific temperature, chosen for reducing the drying time of the coating. In an exemplary embodiment of the present invention, air in the vicinity of the panel is at a temperature between 75 and 85 degrees Fahrenheit.

As the air column comes into contact with the painted surface of the panel 102, the air flows along the painted surface of the panel 102, and the boundaries of the air column are the outer surface of the coating 104 and boundary 108. After a certain distance, the air in the boundary 108 travels in a direction that is substantially parallel to the painted surface of the panel 102, as seen in a region 114.

FIGS. 1b-1f depict the region 114, in which directional turbulence is achieved by pulsating air within the column. In FIG. 1b, a laminar flow is created in the region 114. Air molecules 200 travel non turbulently within the column in the direction of the painted surface of the panel 102. A boundary layer of slowly moving and/or non-moving air molecules 202 is created in the proximity of the coating 104. In FIG. 1c, some solvent molecules 204 evaporate into the boundary layer. The boundary layer is laden with solvent molecules 204 and does not allow any more evaporation of solvent from the coating 104.

In FIG. 1d, a temporary high pressure flow of air is suddenly introduced into the column. This is called as a high pressure air pulse. Because of the air pulse, turbulence is generated, as a pressure wave is created, traveling within the column, and the air molecules 200, which were previously traveling in the direction of the painted surface of the panel 102, tumble toward the coating 104, and break up the boundary layer. Dry air is brought into contact with the coating 104.

In FIG. 1e, as the effects of the high pressure air pulse die down and the air pressure returns to its original value, the airflow within the column becomes laminar again, and a new boundary layer is created. In FIG. 1f, all the solvent molecules 204 evaporate into the boundary layer, leaving the coating 104 dry. If the coating 104 is not dry, another high pressure pulse is generated, in order to break the boundary layer again. Optionally, a low pressure air pulse is generated following each high pressure pulse. Such a feature may be required by some systems in which high pressure pulses are produced, as will be explained below. The high pressure pulse and low pressure air pulse are repeated, unit the coating 104 is dry.

In a variant, the length between each high pressure pulse (herein also called “pulse frequency”) is chosen by a user. Optionally, the pulse frequency is chosen, so that the airflow within the column reaches a desired speed between pulses, in order to ensure that the airflow is not disrupted. According to some embodiments of the present invention, the airspeed of the flow within the column is kept within the range between 200 ft/min and 600 ft/min along the panel. A flow characterized by an airspeed outside this range is generally not favorable for drying waterborne coating, because slower airflow may not deliver enough low relative humidity air to shorten drying time everywhere on the surface of the panel. Faster airflow does not produce additional benefits and may cause defects in the coating, by creating too much pressure on the surface of the wet coating.

In an exemplary embodiment of the present invention, the carrier of the coating is water, and the time between pulses is 5 seconds. This time has been chosen to be long enough to allow airspeed within the column to reach about 450-500 ft/min along the painted surface of the panel, but short enough to be able to generate the next pulse before the boundary layer reaches a level of relative humidity that would slow down the drying process.

According to some embodiments of the present invention, the pulses are generated by turning the air supply on and off. When the air supply is turned on, a high pressure pulse is generated; when the air supplied is turned off, a low pressure pulse is generated. Optionally, the pulses are generated by keeping the air supply on, and opening and closing a blast gate that is installed into the ducting that connects the air supply to the nozzle. The opening and closing of the blast gate is optionally performed by a pneumatic actuator. According to an exemplary embodiment of the present invention, a pneumatic actuator including a cylinder with a 25 mm bore and a 160 mm stroke operates a 6 inch blast gate. The above cylinder is produced by many manufacturers, such as SMC, DingLi, Pisco, Bimba. Optionally, the opening and closing of the blast gate is performed by a damper driven by an electric motor. For example, a fast opening actuator from produced by Belimo generates a sufficiently fast pressure differential rise to create a high pressure pulse needed to create turbulence. Alternatively, a continuously rotating standard electric motor could also be used to close and open an obstruction in the duct system to generate pulses.

Alternatively, pulsing is introduced through a sound wave, which is a pressure wave traveling through air, and disturbs the air column through high and low pressure pulses. For example, a speaker may be used to emit the sound wave. Playing a certain sound at predetermined frequency can create the right waveform to sufficiently disturb the air within the column and create directional turbulence.

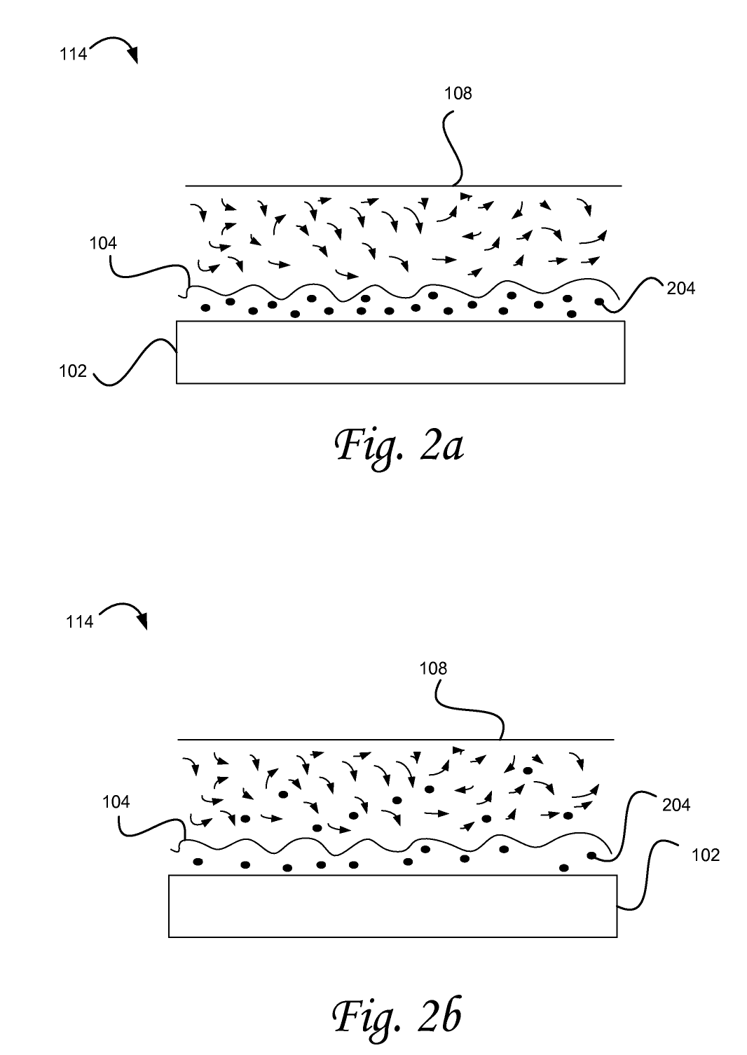

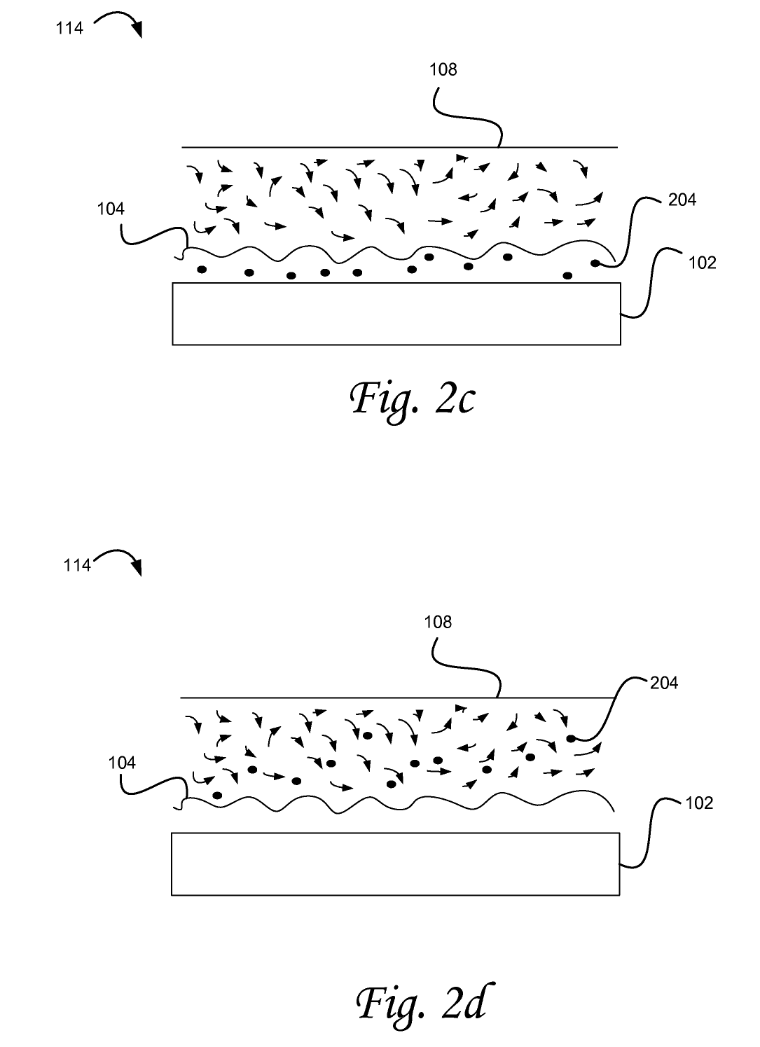

FIGS. 2a-2d are schematic drawings illustrating a painted surface dried by a rotating airflow, according to some embodiments of the present invention.

In FIG. 2a, a blown up image of region 114 of FIG. 1a is shown. Airflow in the column is directionally turbulent, as shown by the arrows representing the airflow. The turbulence is generated by causing the air in the column to rotate relative to the axis of the center line 110 of FIG. 1a. The movement of the air in the air column is a twisting movement, since the rotation is along a plane perpendicular to the direction of the airflow. The twisting turbulence travels with the column along the painted surface of the panel 102. The twisting turbulence prevents the formation of a boundary layer, and therefore reduces the time in which a solvent 204 evaporates from the coating 104.

In FIG. 2b, some solvent molecules 204 of the coating 114 evaporate and enter the air column. The number of solvent molecules 204 within the coating 104 decreases. Because of the turbulence, the molecules 204 of evaporated solvent are quickly spread around the air column, and do not stay near the surface of the coating 104. In FIG. 2c, the molecules 204 of evaporated solvent are pushed away from the coating 104 by the turbulent air, and dry air comes in contact with the coating 104. In FIG. 2d, more molecules of solvent 204 evaporate, leaving the coating 104 dry.

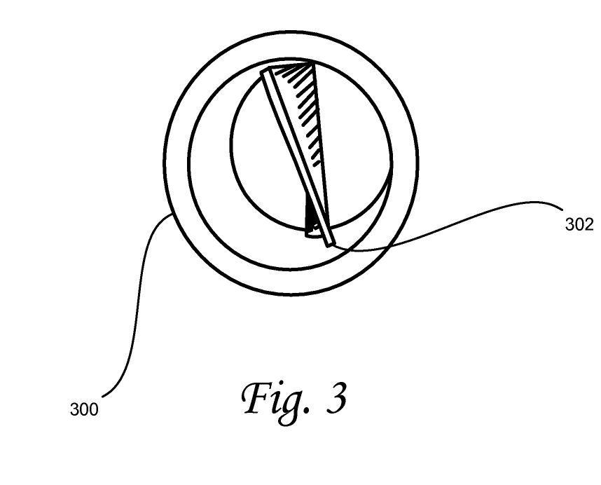

FIG. 3 is a photograph of a nozzle characterized by a twisted surface for twisting the airflow within the column exiting the nozzle, according to some embodiments of the present invention

According to some embodiments of the present invention, a twisting airflow is generated within the air column, in order to achieve directional turbulence. Optionally, this may be done, by flowing air within a nozzle 300 over a twisted surface 302. The air column exiting the nozzle 300 is characterized by air moving in a twisting manner. Such a turbulence travels with the column and does not allow the creation of the boundary layer. Optionally, one ore more other inserts inside the nozzle 300 are used to create turbulence within the air column. For example, one or more small pieces of sheet metal may be attached to the inside wall of the nozzle, to extend into the nozzle cavity. Optionally, a propeller is attached to the nozzle, in order to rotate in the airflow.

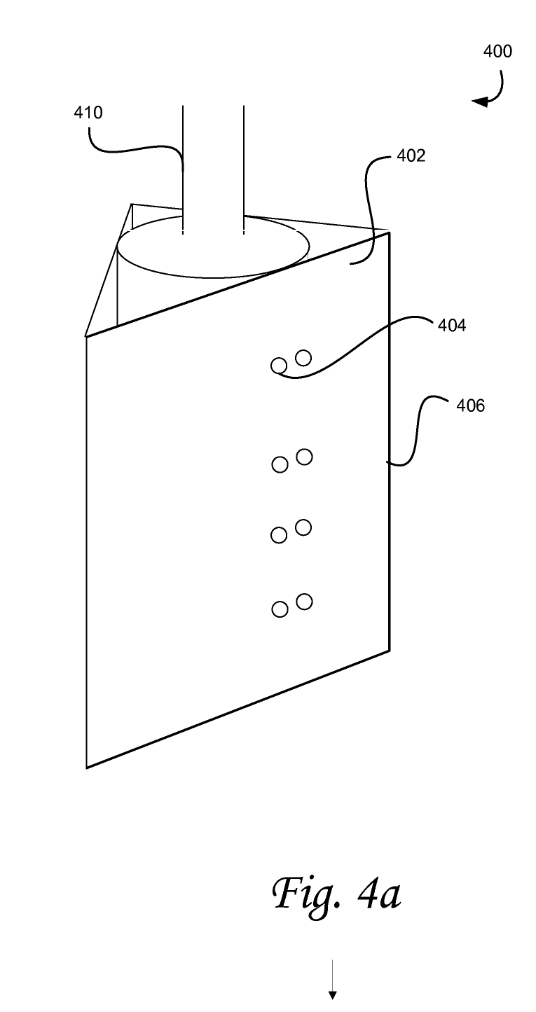

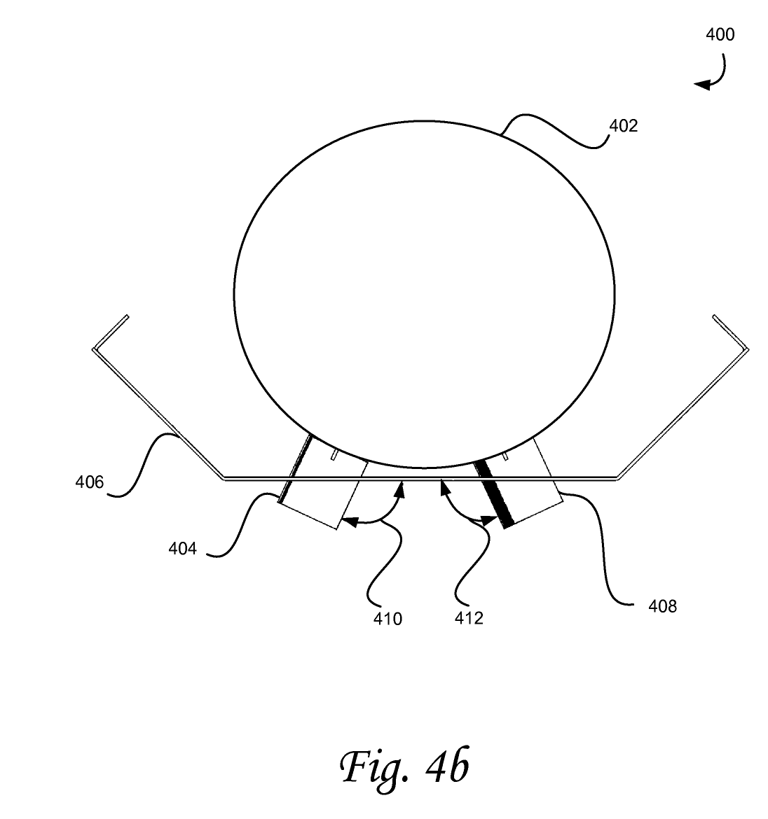

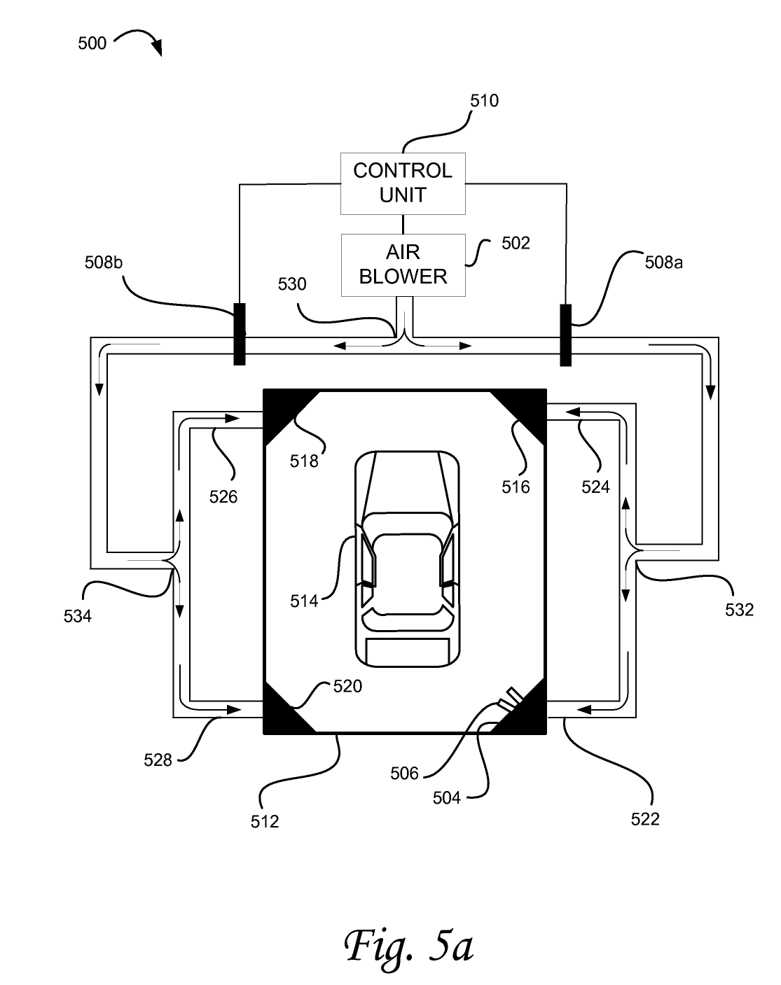

FIGS. 4a and 4b are schematic drawings illustrating a nozzle tower designed for being used in a spray enclosure, according to some embodiments of the present invention.

In FIG. 4a, tower 400 includes a nozzle plenum 402, at least one nozzle 404, and optionally, a nozzle sheet 406. Nozzle plenum 402 receives air from an air blower through a duct 410. The nozzle 404 protrudes from the nozzle plenum 402, and directs the air toward the painted panel. Optionally, the nozzle is held by the nozzle sheet 406. According to an exemplary embodiment of the present invention, the nozzle 404 is an open hollow cylinder characterized by a diameter of 1 inch, and a length of 1.5 inches.

In a variant, the nozzle 404 is attached to the nozzle sheet 406, and may not be moved during operation. Such a feature ensures that the nozzle 404 is not moved out of alignment during operation. If the nozzle were moved out of alignment during operation, a user would have to stop the operation and adjust the nozzle, causing delays in drying of the coating. According to an exemplary embodiment of the present invention, the nozzle 404 is attached to the sheet 406 by two 0.25-inch welds, one on top center and one on the bottom center of the nozzle. With these welds, the nozzle 404 may still be moved, for example by inserting a rod into the nozzle 404 and rotating the rod about the axis formed by connecting the welds. However, such a movement requires substantial force. Bumping into the nozzle 404 or accidentally hitting the nozzle 404 with an object during regular operation does not to exert enough force to move the nozzles out of alignment.

In another variant, the sheet 406 is electrically grounded, and the nozzle 404 is made out of electrically conductive material. In an exemplary embodiment of the present invention, the nozzle 404 is made of galvanized steel, and grounded by being welded to the sheet 406.

Air molecules may become statically charged as they rub against the inside of the nozzle 404. The nozzle 404 of the current invention is grounded through the weld to the nozzle sheet 406 and optionally to the rest of the spray enclosure. This reduces the development of the static charge in the airflow. The reduction of static charge within the airflow is especially important when the coating includes metallic particles. The metallic particles need to be orientated properly, for the appearance of the final finish to be as desired. In a flow, which includes charged air molecules, the charged air molecules may interact with the metallic particles and change the orientation of the metallic particles, causing the color of the final finish to be different than the desired color.

According to some embodiments of the present invention, the tower 400 contains two columns of nozzles. Optionally, the three bottom nozzles are close together, and the top nozzle is removed from the others. This feature is useful in spray enclosures for motor vehicles. The three bottom nozzles are designed for drying coating of passenger vehicles. The top nozzle is designed to effectively dry coating on upper parts of larger vehicles, like trucks and sport utility vehicles (SUVs).

FIG. 4b is a top view of the tower of FIG. 4a. In each column, the nozzles are oriented at the same specific angle relative to the nozzle sheet 406. For example, the nozzles in the column of the nozzle 404 are characterized by an angle 410, and the nozzles in the column of the nozzle 408 are characterized by an angle 412. Optionally, the each column of nozzles is characterized by a different angle with respect to the nozzle sheet 406. The angles 410 and 412 are chosen in order to reduce the angle 112 of FIG. 1 between the panels and the air columns. The angles 410 and 412 depend upon the position of the vehicle in relation to the tower 400.

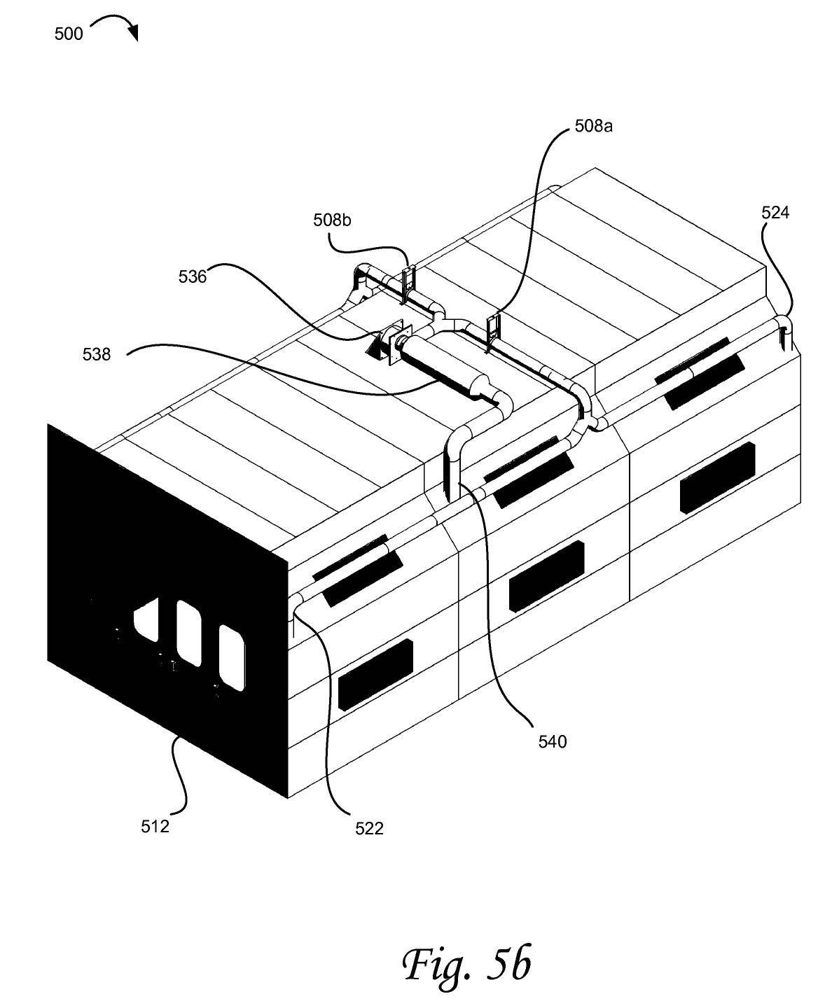

FIGS. 5a and 5b are drawings illustrating a system for drying a coating on a panel, according to some embodiments of the present invention.

System 500 includes an air blower 502, for creating a flow of pressurized air; a nozzle plenum 504, for receiving the pressurized air from the air blower; a nozzle 506, for directing a column of air from the nozzle plenum toward the surface of the panel; a pulse generation unit (508a, 508b), for generating a pulse (and therefore directional turbulence) in the air column; and a control unit 510, for controlling an operation of the system. Optionally a plurality of nozzles is provided, for covering substantially the whole panel, with flowing air. Optionally, an air warming unit is also included in system 500, for warming air before the air exists the nozzle 506. An exemplary air warming unit a 1 MBTU or a 1.5 MBTU direct fired gas heater manufactured by Bananza, or an M1 manufactured by Mercury Air, Inc.

In a variant, the air blower is a 9 1/16 inch×5 inch, wide forward inclined blower direct driven by a 2 horsepower 3,600 RPM electric motor. Optionally, the nozzle plenum 504 is substituted by the tower 400 described in FIG. 4, and is characterized by two columns of nozzles.

In another variant, the pulses are generated by turning the air blower 502 on and off, through the control unit 510. Optionally, the pulses are generated by opening and closing ducting leading air from the air blower 502 to the nozzle plenum 504. The opening and closing of the ducting is performed by the pulse generation unit (508a, 508b). The pulse generation unit is optionally a pneumatic actuator or a damper driven by an electric motor, both of which have been described above.

According to some embodiments of the present invention, the control unit 510 is designed to turn the air blower 502 on and off. In an exemplary embodiment of the present invention, the control unit 510 includes a motor control box of the type CR453XE1A, manufactured by General Electric. Optionally, the control unit 510 further includes a timer, for turning the air blower 502 on and off at a specific frequency. In a variant, the control unit 510 controls the operation of the pulse generation unit. In another variant, the control unit 510 contains a user interface, for receiving an input from a user, for example the pulse frequency, and the total time of the operation. Optionally, the control unit 510 includes a computer.

According to some embodiments of the present invention, the system 512 is designed to be installed within a spray enclosure 512, and for drying water based coating on a motor vehicle 514. According to some embodiments of the present invention, four plenums are set within the spray enclosure 512, each plenum at one corner of the spray enclosure 512. Air is supplied to the plenum 504, by a duct 522; to a plenum 516, by a duct 524; to a plenum 518, by a duct 526; and to a plenum 520 by a duct 528. Plenums 504, 516, 518, and 520 may be substituted by towers, such as the tower 400 of FIGS. 4a and 4b.

In yet a further variant, four towers substitute the four plenums, and each tower is positioned in the spray enclosure 512 so that the nozzle sheet of each plenum is set at a 45 degree angle with both walls touched by the plenum. The angles 410 and 412 of FIG. 4b are chosen according to the size of the spray enclosure 512. In an exemplary embodiment of the present invention, the spray enclosure 512 is 24 feet long, 14 feet wide, and 9 feet high. Accordingly, the angle 410 is chosen to be 110 degrees, in order to aim the nozzle at the short dimension (the rear or the front) of the vehicle; the angle 412 is chosen to be 105 degrees, to aim the nozzle at the long dimension (the side) of the vehicle. In this manner, the four towers effectively cover the surface of a passenger car.

In an exemplary embodiment of the present invention, the air blower 502 blows air into a ducting. At a junction 530, the air is split into two streams. The first stream is sent towards a junction 532, and passes through an element 508a of the pulse generation unit. The second stream is sent toward junction 534, and passes through an element 508b of the pulse generation unit. When element 508a is open, element 508b is closed and, air flows to the towers 504 and 516. When element 508b is open, element 508a is closed and, air flows to towers 518 and 520. A high pressure pulse is generated in the air columns flowing from towers 504 and 516, while no air flow reaches the towers 518 and 520, thereby generating a low pressure pulse in the air columns exiting the towers 518 and 520. After a specific length of time (for example, 5 seconds), element 508a is closed, and element 508b is opened. A low pressure pulse is generated in the air columns flowing from towers 504 and 516, while a high pressure pulse is generated in the air columns flowing from the towers 518 and 520. This is repeated, until the coating on the vehicle 514 is dry.

According to some embodiments of the present invention, air from spray enclosure 512 is pumped out of the spray enclosure 512 by a pump 536 included in the blower 502, through a duct 540, and fed by the blower 502 back into the spray enclosure 512 through the nozzles . Optionally, a filter 538 is located on the duct 540, for filtering the air that taken out of the booth 512 by the pump 536. Optionally, the air is pumped out of the top section of the spray enclosure 512. Air in the top section of the spray enclosure is warmer (sometimes by 15 degrees Fahrenheit) than the air in the bottom. Warm air is therefore recirculated into the bottom section of the spray enclosure 512. This feature provides a more homogeneous temperature within the spray enclosure 512, and may reduce the use of the air warming unit or a heater already included in the spray enclosure 512, resulting in lower operating costs.

It should be noted that the system 500 is not reliant on crashing a primary vertical spray enclosure airflow into a horizontal secondary turbulence for creating system airflow in order to create turbulence. The primary airflow of the spray enclosure could be turned off, since the system 500 generates its own turbulence, independently of the spray enclosure airflow style or design. According to some embodiments of the present invention, the system 500 generates an airflow, which is horizontal with respect to the ground. Such a setup may reduce the amount of overspray particles that is stirred up, during the operation of the system 500.

In some embodiments of the present invention, the system 500 generates a horizontal secondary airflow, and is coupled to a system for generating a primary airflow. If coupled with a primary vertical airflow, the secondary airflow produces a turbulence, which travels vertically along the primary airflow. If coupled with a primary horizontal airflow, the secondary airflow produces a turbulence, which travels horizontally along the primary airflow. Such a turbulence makes the primary airflow more efficient in drying a coating, as described above, and may therefore reduce the drying time of the coating. Thus, the above method may be applied to drying a coating in a spray enclosure characterized by a primary horizontal airflow.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof, the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for forcing evaporation of a solvent from a coating on a surface of a panel, comprising:
directing air to flow along the surface of the panel; and
generating turbulence in the air within the column, by creating one or more high pressure pulses of air within the airflow;
wherein the turbulence travels in the direction of the airflow, replacing air laden with vapor adjacent to the surface of the panel with dry air, thereby accelerating drying.

2. The method of claim 1, wherein the high pressure pulses are delivered at a chosen frequency and the air is directed toward the surface of the panel through a nozzle in the form of an air column, the column being inclined to the plane of the panel, such that the airflow travels along the surface of the panel.

3. The method of claim 2, wherein a plurality of columns of air is directed toward the panel, each column through a different nozzle, so that air from the columns flows over substantially the whole surface of the panel.

4. The method of claim 1, wherein a low pressure pulse follows each high pressure pulse.

5. The method of claim 4, wherein creating high pressure and low pressure pulses is achieved by turning the air supply on and off at the chosen frequency.

6. The method of claim 4, wherein creating high pressure and low pressure pulses is achieved by opening and closing ducting leading air from the air supply to the nozzle, at the chosen frequency.

7. The method of claim 4, wherein creating high pressure and low pressure pulses is achieved by introducing a sound wave, for disturbing the air flowing along the surface of the panel, thereby creating turbulence in the airflow.

8. The method of claim 1, wherein the solvent is water and the coating is waterborne coating.

9. The method of claim 1, further comprising:
generating further turbulence within the air column, by forcing air within the column to rotate.

10. The method of claim 9, wherein forcing air to rotate is achieved by flowing air within the nozzle over a twisted surface inside the nozzle.

11. A system for forcing evaporation of a solvent from a coating on a surface of a panel, comprising:
an air blower, for creating a flow of pressurized air;
a nozzle plenum, for receiving the pressurized air from the air blower;
a nozzle, for directing a column of air from the nozzle plenum toward the surface of the panel;
a pulse generation unit, for generating a pressure pulse in the air column, thereby creating turbulence in air within the column, the pulse being characterized by a chosen frequency; and
a control unit, for controlling an operation of the system;
wherein the column of air is inclined to the plane of the panel, such that the air within the column flows along the surface of the panel, and the turbulence travels in the direction of the flow, replacing air laden with solvent vapor adjacent to the surface with dry air, thereby accelerating drying.

12. The system of claim 11, comprising a plurality of nozzles, each nozzle configured for directing a column of air toward the panel, so that air from the columns flows over substantially the whole surface of the panel.

13. The system of claim 11, wherein the frequency is chosen, such that the air in the column reaches a desired speed between pulses.

14. The system of claim 11, wherein the pulse generation unit comprises a timer connected to the control unit, and configured for turning the blower on and off at the chosen frequency.

15. The system of claim 11, wherein the pulse generation unit comprises a damper configured for opening and closing tubing leading air from the air blower to the nozzle plenum at the chosen frequency.

16. The system of claim 11, further comprising a twisted surface located within the nozzle, for generating a twisting airflow within the column, thereby creating further turbulence within the column.

17. A spray enclosure for drying a coating on a surface of a vehicle, comprising the system of claim 11.

18. A system for forcing evaporation of a solvent from a coating on a surface of a panel, and configured for being placed in a spray enclosure for painting and drying a vehicle, comprising:
an air blower, for creating a flow of pressurized air;
a nozzle plenum, for receiving the pressurized air from the air blower; and
a nozzle sheet, for supporting one or more nozzles, each nozzle directing a jet of air from the nozzle plenum toward the surface of the panel, wherein nozzle is pointed at a specific angle, chosen so that the airjets are inclined to the plane of the panel, such that the air from the air jets flows along a surface of the vehicle;
a control unit, for controlling an operation of the blower;
wherein the nozzle is held in place by the nozzle sheet, and is not movable.

19. The system of claim 18, wherein the nozzle is grounded and made out of an electrically conductive material, to reduce a generation of static charge by the air rubbing rubs against the inside of the nozzle.

20. The system of claim 19, wherein the spray enclosure is rectangular, and comprising four nozzle plenums, such that:
on the first sheet, located on the first wall, one column of nozzles generates jets flowing in a laminar manner along a back surface of the vehicle, and the other column of nozzles generates jets flowing in a laminar manner along a surface of a first side of the vehicle;
on the second sheet, located on the first wall, one column of nozzles generates jets flowing in a laminar manner along the surface of the first side of the vehicle, and the other column of nozzles generates jets flowing in a laminar manner along a front surface of the vehicle;
on the third sheet, located on the second wall and opposite the second sheet, one column of nozzles generates jets flowing in a laminar manner along the front surface of the vehicle, and the other column of nozzles generates jets flowing in a laminar manner along a surface of a second side of the vehicle; and
on the fourth sheet, located on the second wall and opposite the first sheet, one column of nozzles generates jets flowing in a laminar manner along the surface of the second side of the vehicle, and the other column of nozzles generates jets flowing in a laminar manner along the back surface of the vehicle.
